(19) United States
(12) Patent Application Publication
(10) Pub. No.: US 2018/0025214 A1
(43) Pub. Date: Jan. 25, 2018

(54) FACE RECOGNITION METHOD

(71) Applicant: HON HAI PRECISION INDUSTRY CO., LTD., New Taipei (TW)

(72) Inventors: TIEN-PING LIU, New Taipei (TW); I-HAO CHUNG, New Taipei (TW); KUEI-KANG WU, New Taipei (TW); HORNG-JUING LEE, New Taipei (TW)

(21) Appl. No.: 15/469,671

(22) Filed: Mar. 27, 2017

(30) Foreign Application Priority Data
Jul. 25, 2016 (TW) 105123407

(51) Int. Cl. G06K 9/00; G06F 17/30; G06K 9/62

(52) U.S. Cl. CPC G06K 9/00288; G06K 9/6202; G06F 17/30259; G06F 17/3028

(57) ABSTRACT

The disclosure relates to a face recognition method. The face recognition method includes: providing a face recognition system, the face recognition system includes a database module, a camera module, and a feature point compare module, wherein the database module stores a plurality of data-photos of a plurality of users; turning on the face recognition system to a searching motion, and searching person faces by the camera module to get a target person face of a target person; and, turning on the face recognition system to a recognition motion to judge whether the target person is one user.

### CROSS-REFERENCE TO RELATED APPLICATIONS

This application claims all benefits accruing under 35 U.S.C. §119 from Taiwan Patent Application No. 105123407, filed on Jul. 25, 2016, in the Taiwan Intellectual Property Office, the contents of which are hereby incorporated by reference.

### FIELD

The subject matter herein generally relates to a face recognition method.

### BACKGROUND

Face recognition is a biometric technology which is based on the identification of human face feature information. Face images or video can be captured by the video camera and automatically detected and tracked by face recognition.

With the technology development, face recognition has been applied in many fields, for example, face recognition attendance system, face recognition anti-theft door, face recognition to unlock the phone, face recognition to run with the robot. In a conventional face recognition, the camera is used to take data-photos of consumers, and theses data-photos are stored in a database. In use of the face recognition, the camera is used to take a scene-photo of the people, and the scene-photo is compared with the data-photos to judge whether the people is a consumer. However, only feather parameters are used to compare the scene-photo and the data-photo, and the face recognition method has a high mistake rate.

What is needed, therefore, is to provide a face recognition method which can overcome the shortcomings as described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a flow chart of one embodiment of a face recognition method.

### DETAILED DESCRIPTION

It will be appreciated that for simplicity and clarity of illustration, where appropriate, reference numerals have been repeated among the different FIGURES to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The connection can be such that the objects are permanently connected or releasable connected. The term “substantially” is defined to be essentially conforming to the particular dimension, shape or other word that substantially modifies, such that the component need not be exact. The term “comprising” means “including, but not necessarily limited to”; it specifically indicates open-ended inclusion or membership in a so-described combination, group, series and the like. It should be noted that references to “an” or “one” embodiment in this disclosure are not necessarily to the same embodiment, and such references mean at least one.

The present disclosure relates to face recognition methods described in detail as below.

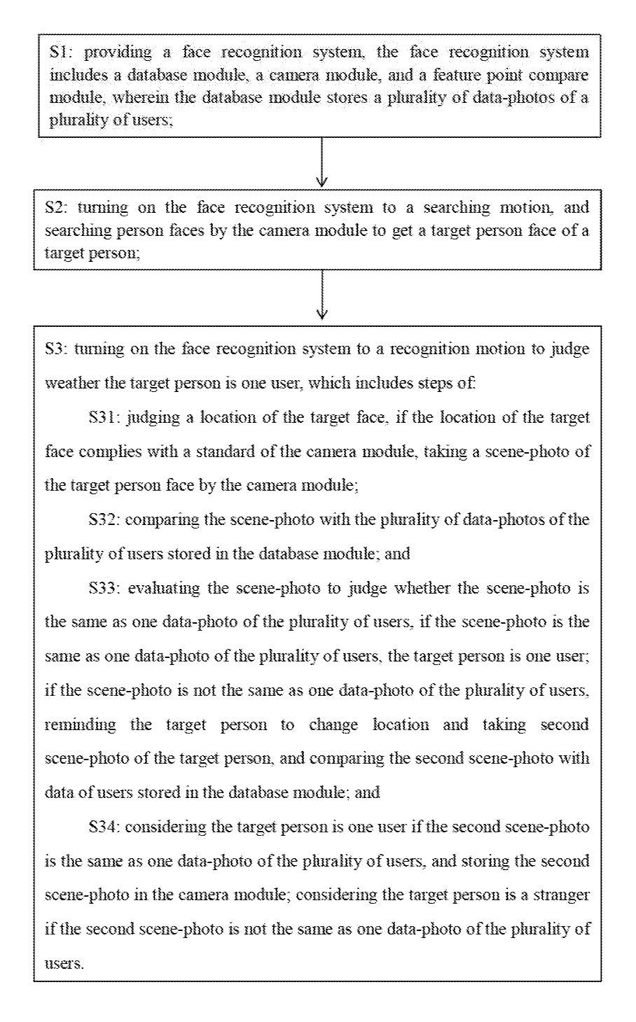

Referring to FIG. 1, a face recognition method of one embodiment is provided. The face recognition method includes steps of:

S1: providing a face recognition system, the face recognition system includes a database module, a camera module, and a feature point compare module, wherein the database module stores a plurality of data-photos of a plurality of users;

S2: turning on the face recognition system to a searching motion, and searching person faces by the camera module to get a target person face of a target person;

S3: turning on the face recognition system to a recognition motion to judge whether the target person is one user, which includes steps of:

S31: judging a location of the target face, if the location of the target face complies with a standard of the camera module, taking a scene-photo of the target person face by the camera module;

S32: comparing the scene-photo with the plurality of data-photos of the plurality of users stored in the database module; and

S33: evaluating the scene-photo to judge whether the scene-photo is the same as one data-photo of the plurality of users, if the scene-photo is the same as one data-photo of the plurality of users, the target person is one user; if the scene-photo is not the same as one data-photo of the plurality of users, reminding the target person to change location and taking second scene-photo of the target person, and comparing the second scene-photo with data of users stored in the database module;

S34: considering the target person is one user if the second scene-photo is the same as one data-photo of the plurality of users, and storing the second scene-photo in the camera module; considering the target person is a stranger if the second scene-photo is not the same as one data-photo of the plurality of users.

In step S1, each user has at least one data-photos. Each data-photo includes a group of data-camera parameters and a group of data-feather parameters. The data-camera parameters are parameters of the camera when takes data-photos, such as white balance, ISO, diaphragm, shutter, color temperature, pixel, brightness, contrast ratio, time and light. The data-feather parameters are feather size of the data-photos, such as, area of person face, distance between eyes, size of eye, distance between eye and mouth.

In step S1, the camera module is configured to take a scene-photo of the target person. The scene-photo includes a group of scene-camera parameters and a group of scene-feather parameters. The scene-camera parameters are parameters of the camera when takes scene-photo, such as white balance, ISO, diaphragm, shutter, color temperature, pixel, brightness, contrast ratio, time and light. The scene-feather parameters are feather size of the scene-photos, such as, area of person face, distance between eyes, size of eye, distance between eye and mouth.

In step S1, every photo including data-photo and scene-photo has camera parameters and feather parameters. The feature point compare module is configured to compare the scene-photo of the target person with the data-photos of the plurality of users to judge whether the target person is one user.

In step S32, the step of comparing the scene-photo with the plurality of data-photos of the plurality of users stored in the database module includes sub-steps of:

Sa: comparing the group of scene-camera parameters of the scene-photo with the group of data-camera parameters of each data-photos to calculate x groups of data-camera parameters of x data-photos that are most similar to the group of data-camera parameters, wherein x is the number of groups of data-camera parameters and the number of data-photos, x≧1; and

Sb: comparing the x groups of data-feather parameters of the x data-photos with the group of scene-feather parameters of the scene-photo to evaluate the scene-photo.

In step Sa, the group scene-camera parameters and the data-camera parameters have L same values and K similar values. The K similar values means the K values are different from each other, and the differences is less than 5%, such as 3%, 1%.

In the step Sa, in one embodiment, the calculate step includes: calculating L, the greater the L, the more similar the group scene-camera parameters and the data-camera parameters.

In the step Sa, in another embodiment, the calculate step includes: calculating K, the greater the K, the more similar the group scene-camera parameters and the data-camera parameters.

In the step Sa, in yet another embodiment, the calculate step includes: comparing L and K, if L is greater than K, the greater the L, the more similar the group scene-camera parameters and the data-camera parameters; if K is greater than L, the greater the K, the more similar the group scene-camera parameters and the data-camera parameters.

In the step Sa, in yet another embodiment, the calculate step includes: calculating a sum of K and L, the greater the sum of K and L, the more similar the group scene-camera parameters and the data-camera parameters.

In step Sb, the step of evaluate the scene-photo is operated by scoring the scene-photo. If a difference of the scene-feather parameter and the data-feather parameter is less than 1% or 2%, the scene-feather parameter and the data-feather parameter is regarded as the same with each other. If the scene-photo has y scene-feather parameters the same as data-feather parameters of one data-photo, the greater of y, the higher score the scene-photo has. In one embodiment, a total score of the scene-photo is 100, and a total number of the scene-feather parameters is Y, if y/Y is 10%, the score of the scene-photo is 10; if y/Y is 50%, the score of the scene-photo is 50; if y/Y is 90%, the score of the scene-photo is 90; and so on. In one embodiment, if the score of the scene-photo is greater than 60, the target person is regarded as the user. In another embodiment, the score of the scene-photo can be equal to y, if y is greater than 5, the target person is regarded as the user.

In step S33, the step of comparing the second scene-photo with data of users stored in the database module is the same as the step S32.

In step S34, if the target person is regarded as a stranger, an alarm can be emitted to notify workers operating the face recognition system.

The face recognition method is simple, and can be applied to both multi-lens or RGBD system and small electric device such as mobile phone. The face recognition method combines camera parameters and feather parameters when judging a target person, and has a high accuracy.

The embodiments shown and described above are only examples. Even though numerous characteristics and advantages of the present technology have been set forth in the forego description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Depending on the embodiment, certain of the steps of methods described may be removed, others may be added, and the sequence of steps may be altered. The description and the claims drawn to a method may include some indication in reference to certain steps. However, the indication used is only to be viewed for identification purposes and not as a suggestion as to an order for the steps.

What is claimed is:

1. A face recognition method comprising:
S1: providing a face recognition system, the face recognition system includes a database module, a camera module, and a feature point compare module, wherein the database module stores a plurality of data-photos of a plurality of users;
S2: turning on the face recognition system to a searching motion, and searching person faces by the camera module to get a target person face of a target person;
S3: turning on the face recognition system to a recognition motion to judge whether the target person is one user, which comprises steps of:
S31: judging a location of the target face, if the location of the target face complies with a standard of the camera module, taking a scene-photo of the target person by the camera module;
S32: comparing the scene-photo with the plurality of data-photos of the plurality of users stored in the database module; and
S33: evaluating the scene-photo to judge whether the scene-photo is the same as one data-photo of the plurality of users, if the scene-photo is the same as one data-photo of the plurality of users, the target person is one user; if the scene-photo is not the same as one data-photo of the plurality of users, reminding the target person to change location and taking second scene-photo of the target person, and comparing the second scene-photo with data of users stored in the database module;
S34: considering the target person is one user if the second scene-photo is the same as one data-photo of the plurality of users, and storing the second scene-photo in the camera module; considering the target person is a stranger if the second scene-photo is not the same as one data-photo of the plurality of users.

2. The method of claim 1, wherein in step S1, each of the plurality of user has at least one data-photo, each of the plurality of data-photos has a group of data-camera parameters and a group of data-feather parameters.

3. The method of claim 2, wherein the group of data-camera parameters comprises white balance, ISO, diaphragm, shutter, color temperature, pixel, brightness, contrast ratio, time and light.

4. The method of claim 2, wherein the group of data-feather parameters comprises area of person face, distance between eyes, size of eye, distance between eye and mouth.

5. The method of claim 1, wherein the scene-photo comprises a group of scene-camera parameters and a group of scene-feather parameters, the group of scene-camera parameters comprises parameters of the camera module taking a scene-photo, the group of scene-feather parameters is feather sizes of the scene-photos.

6. The method of claim 5, wherein the group of scene-feather parameters comprises white balance, ISO, diaphragm, shutter, color temperature, pixel, brightness, contrast ratio, time and light.

7. The method of claim 5, wherein the group of scene-feather parameters comprises an area of person face, a distance between eyes, a size of eye, a distance between eye, mouth, and a size of mouth.

8. The method of claim 1, wherein the feature point compare module is configured to compare the scene-photo of the target person with the plurality of data-photos of the plurality of users to judge whether the target person is one user.

9. The method of claim 1, wherein in step S32, each of the plurality of data-photos has a group of data-camera parameters and a group of data-feather parameters, the scene-photo comprises a group of scene-camera parameters and a group of scene-feather parameters, the step of comparing the scene-photo with the plurality of data-photos of the plurality of users stored in the database module comprises:
Sa: comparing the group of scene-camera parameters of the scene-photo with the group of data-camera parameters of each data-photos to calculate x groups of data-camera parameters of x data-photos that are most similar to the group of data-camera parameters, wherein x is the quantity of groups of data-camera parameters and the quantity of data-photos, x≧1; and
Sb: comparing the x groups of data-feather parameters of the x data-photos with the group of scene-feather parameters of the scene-photo to evaluate the scene-photo.

10. The method of claim 9, wherein in the step Sa, the group scene-camera parameters and the data-camera parameters have L same values and K similar values, the K similar values are K values different from each other, and the differences is less than 5%.

11. The method of claim 9, wherein in the step Sa, the calculate step comprises: calculate L, the greater the L, the more similar the group scene-camera parameters and the data-camera parameters.

12. The method of claim 9, wherein in the step Sa, the calculate step comprises: calculate K, the greater the K, the more similar the group scene-camera parameters and the data-camera parameters.

13. The method of claim 9, wherein in the step Sa, the calculate step comprises: comparing L and K, if L is greater than K, the greater the L, the more similar the group scene-camera parameters and the data-camera parameters; if K is greater than L, the greater the K, the more similar the group scene-camera parameters and the data-camera parameters.

14. The method of claim 9, wherein in the step Sa, the calculate step comprises: calculating a sum of K and L, the greater the sum of K and L, the more similar the group scene-camera parameters and the data-camera parameters.

15. The method of claim 9, wherein the step of evaluating the scene-photo is operated by scoring the scene-photo, if a difference of the scene-feather parameter and the data-feather parameter is less than 1% or 2%, the scene-feather parameter and the data-feather parameter is regarded as the same with each other.

16. The method of claim 15, wherein the scene-photo has y scene-feather parameters the same as data-feather parameters of one data-photo, the greater of y, the higher score the scene-photo has.
